(19) United States
(12) Patent Application Publication
(10) Pub. No.: US 2007/0055395 A1
(43) Pub. Date: Mar. 8, 2007

(54) Audio system controlling

(76) Inventors: Lisa Debettencourt, Lowell, MA (US); Neil W. Griffiths, Lexington, MA (US)

Correspondence Address: FISH & RICHARDSON PC, P.O. BOX 1022, MINNEAPOLIS, MN, 55440-1022, US

(21) Appl. No.: 11/211,064

(22) Filed: Aug. 24, 2005

(51) Int. Cl. G06F 17/00

(52) U.S. Cl. 700/94

(57) ABSTRACT

An audio system includes an audio device for processing an audio signal and a controller having a control switch that controls a function of the audio device. An external device may be coupled to the audio device to modify the function of the audio device. The control switch controls a modified function of the audio device when the external device is coupled to the audio device.

The present invention relates in general to audio system controlling and more particularly to controlling an audio system that may be coupled to an external device.

### BACKGROUND OF THE INVENTION

Audio systems are generally controlled through a control panel that is integrated with the audio system and/or through a remote controller. Each push button or switch on the control panel or the remote control controls a different function of the audio system. External devices that are connected to the audio system can be controlled by a dedicated remote control or by a universal remote control. Different control switches on the universal remote control can control different functions on the audio system and the external device.

### SUMMARY OF THE INVENTION

It is an important object of the invention to control an audio system that may be coupled to an external device.

In one aspect, the invention is related to methods and apparatus for controlling an audio system. An audio system according to the invention includes an audio device for processing an audio signal. The audio system also includes a controller having a control switch. The control switch controls a function of the audio device. An external device is connected to the audio device. The connection of the external device modifies the function of the audio device. The control switch controls a modified function of the audio device when the external device is connected to the audio device. In one embodiment, the control switch controls a function of the external device when the external device is connected to the audio device.

The audio device can embody a multimedia entertainment system, a stereo system, or a computer. Additionally, the audio device can embody an amplifier, a tuner, a CD player, a MP3 player, a DVD player, a cellular telephone, or a storage device. The external device can embody a MP3 player, a cellular telephone, a satellite telephone, a DVD player, a CD player, a PDA, a digital camera, a multiple-compact disk changer, a portable music device, a radio receiver, a satellite receiver, or another audio device.

The controller can embody a remote controller or a control panel that is integrated with the audio device. The remote controller can be operated by voice command. The control switch can include a CD select switch, source select switch, track select switch, skip forward switch, skip backward switch, fast forward switch, rewind switch, pause switch, play switch, slow play switch, stop switch, station select switch, and AM/FM band switch.

The external device can be connected to the audio device with a cable or a docking cradle that is connected to the audio device. The docking cradle is adapted to receive the external device. In one embodiment, the external device is wirelessly connected to the audio device. The external device can be connected to the audio device through an interface element. The interface element can translate a communication protocol that is native to the external device to a communication protocol that is native to the audio device. The interface element can translate a communication protocol that is native to the audio device to a communication protocol that is native to the external device. The interface element can be integrated with a docking cradle. The external device can be powered by the audio device or the audio device can be powered by the external device.

In another aspect, the invention is embodied in a method for controlling an audio system. The method includes selecting a control switch on a controller. The control switch transmits a signal to an audio device in the audio system to control a function of the audio device. The method also includes connecting an external device to the audio device. The connection of the external device modifies the function of the audio device. The signal controls a modified function of the audio device when the external device is connected to the audio device. The signal can control a function of the external device when the external device is connected to the audio device. In one embodiment, the external device is identified after it is connected to the audio device.

The audio device can embody a multimedia entertainment system, a stereo system, or a computer. The external device can embody a MP3 player, a cellular telephone, a satellite telephone, a DVD player, a CD player, a PDA, a digital camera, a multiple-compact disk changer, a portable music device, a radio receiver, a satellite receiver, or another audio device.

The controller can embody a remote controller or a control panel that is integrated with the audio device. The function of the audio device can include CD select function, source select function, track select function, skip forward function, skip backward function, fast forward function, rewind function, pause function, play function, slow play function, stop function, station select function, and AM/FM band function.

The method can include connecting the external device to the audio device with a cable or a docking cradle. The docking cradle is adapted to receive the external device. The method can also include powering the external device with the audio device or the powering the audio device with the external device. The method can include connecting the external device to the audio device wirelessly.

The method can also include translating a communication protocol that is non-native to the audio device to a communication protocol that is native to the audio device. The method can also include translating a communication protocol that is non-native to the external device to a communication protocol that is native to the external device.

In another aspect, the invention is embodied in an audio system. The audio system includes an audio device for processing an audio signal. A controller having a control switch controls a function of the audio device. An interface element is connected to the audio device. The interface element has a communication protocol that is native to the audio device. An external device is connected to the interface element. The connection of the external device modifies the function of the audio device such that the control switch controls a modified function of the audio device when the external device is connected to the audio device.

The control switch can control a function of the external device when the external device is connected to the audio device. In one embodiment, the controller is a remote controller.

The external device can be a MP3 player, a cellular telephone, a satellite telephone, a DVD player, a CD player, a multiple-compact disk changer, a portable music device, a radio receiver, a satellite receiver, or another audio device. The audio device can be a multimedia entertainment system, a stereo system, or a computer. Additionally, the audio device can be an amplifier, a tuner, a CD player, a MP3 player, a DVD player, a cellular telephone, or a storage device.

The interface element translates a communication protocol that is native to the external device to a communication protocol that is native to the audio device. The interface element could translate a communication protocol that is native to the audio device to a communication protocol that is native to the external device. In one embodiment, the interface element comprises a docking cradle that is connected to the audio device. The docking cradle is adapted to receive the external device.

Other features, objects and advantages of this invention may be better understood by referring to the following description in conjunction with the accompanying drawing in which:

### BRIEF DESCRIPTION OF THE SEVERAL VIEWS OF THE DRAWING

FIG. 1 is a block diagram of an audio system having an audio device that is coupled with one or more external devices according to the invention;

FIG. 2 illustrates a remote controller for controlling the audio system of FIG. 1;

FIG. 3 is a flowchart of a method of controlling the audio system of FIG. 1; and

FIG. 4 is a flowchart of another method of controlling the audio system of FIG. 1.

### DETAILED DESCRIPTION

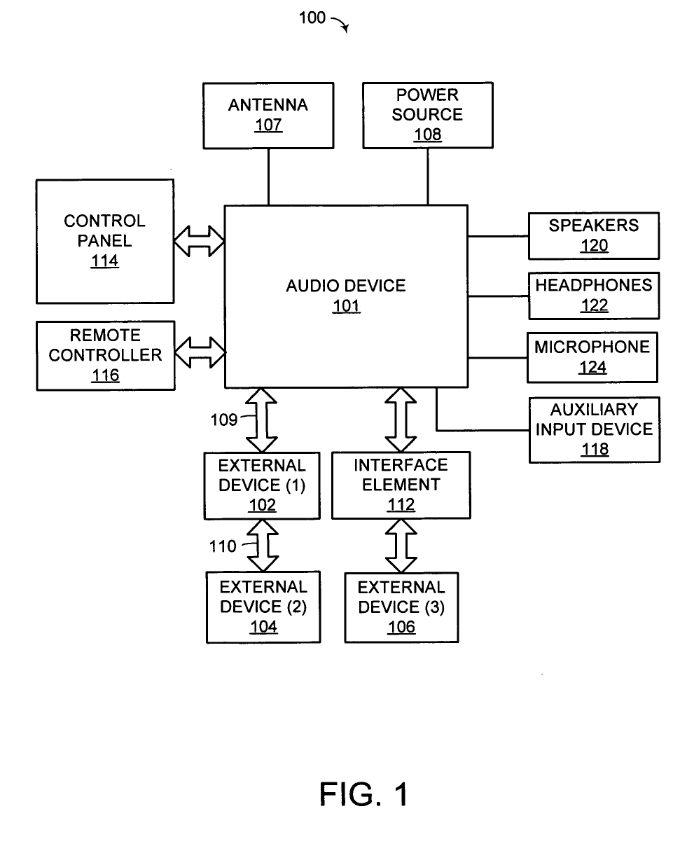

FIG. 1 is a block diagram of an audio system 100 having an audio device 101 that is coupled with one or more external devices 102, 104, and 106 according to the invention. The audio system 100 can encompass an entertainment system such as a stereo system or a video entertainment system. The audio device 101 can include an integrated compact disk (CD) player or CD changer, for example. Additionally, the audio device can include an integrated radio and/or satellite tuner, amplifier, display, and other elements, such as control switches and control knobs. An antenna 107 can be coupled to the radio and/or satellite tuner. For example, the antenna 107 can be an FM antenna, an AM loop antenna or a dish-type antenna. The audio device 101 can also include a microprocessor executing software that controls functions of the audio device 101.

An optional power source 108, such as an AC source or a DC source can supply power to the audio device 101. In one embodiment, once powered, the audio device 101 supplies power to the external devices 102, 104, and 106. In another embodiment, one of the (powered) external devices 102, 104, and 106 can supply power to the audio device 101. In another embodiment, each of the devices 101, 102, 104, 106 includes its own power source.

The external devices 102, 104, and 106 can include MP3 players, cellular telephones, satellite telephones, digital video disk (DVD) players, CD players, personal digital assistants (PDAs), digital cameras, multiple-compact disk changers, portable music devices, radio receivers, satellite receivers, or other audio devices. The external devices 102, 104, and 106 can be connected to the audio device 101 through a cable or a docking cradle, for example. In another embodiment, the audio device 101 can mate with one of the external devices 102, 104, and 106 to form an integrated system. In this embodiment, the electrical connection can be made through internal connectors or an external cable, for example. In one embodiment, one or more of the external devices 102, 104, and 106 are connected to the audio device through a wireless link. For example, the wireless link can be an optical link (e.g., infrared) or a radio frequency (RF) link.

The first external device 102 can be coupled to the audio device 101 through a bi-directional transmission link 109. The bi-directional transmission link 109 can transmit control signals and/or data signals between the first external device 102 and the audio device 101. In one embodiment, control signals are transmitted from the audio device 101 to the first external device 102 through a unidirectional transmission link (not shown). In one embodiment, data signals, such as audio signals are transmitted from the first external device 102 to the audio device 101 through a unidirectional data transmission link (not shown).

The bi-directional transmission link 109 uses a protocol that is known or native to both the audio device 101 and first external device 102. Thus, control signals that are transmitted from the audio device 101 to the first external device 102 can be understood by the first external device 102 without the requirement of an interface layer between the two devices 101, 102. Similarly, control signals that are transmitted from the first external device 102 to the audio device 101 can be can be understood by the audio device 101 without the requirement of an interface layer between the two devices 101, 102. In one embodiment, audio signals are transmitted from the first external device 102 to the audio device 101 through the bi-directional transmission link 109 or through another transmission link (not shown).

The second external device 104 can be coupled to the first external device 102 through a bi-directional transmission link 110. Other external devices (not shown) can be similarly daisy-chained in this manner. The bi-directional transmission link 110 is similar to the bi-directional transmission link 109. The second external device 104 can optionally be coupled to the first external device 102 through a unidirectional transmission link 110.

The third external device 106 can be coupled to the audio device 101 through an interface element 112. This assumes that the audio device 101 and the third external device 106 do not share the sane communication protocol. The interface element 112 can be a protocol translator. For example, the third external device 106 can be a third-party device having an entirely different communication protocol than the audio device 101. In this embodiment, the interface element 112 can translate the communication protocol between the third external device 106 and the audio device 101. The communication protocol can include commands or data, for example.

The audio device 101 can also include a control panel 114. The control panel 114 can be integrated with the audio device 101. The control panel 114 can include control switches, control knobs, and/or a display screen. The display screen can display system status, artist/title or other track information and/or radio data system (RDS) information, for example. The control panel includes control switches that can control functions of the audio device 101 as well as functions of the external devices 102, 104, and 106.

The control panel 114 can include at least one control switch that controls a function of the audio device 101 prior to an external device 102, 104, 106 being connected to the audio device 101. The connection of the external device 102, 104, 160 modifies the function of the audio device 101 such that the control switch controls a modified function of the audio device 101 when the external device 102, 104, 106 is connected to the audio device 101. For example, in a first mode of operation, the control switch controls a function of the audio device 101, such as the selection of a compact disk (CD) source that is integrated with the audio device 101 before the external device 102 is connected to the audio device 101. In a second mode of operation, upon connection of the external device 102 to the audio system 100 the function of the audio device is modified such that the control switch (CD selection) controls a function of the external device 102. In one embodiment, the connection of the external device 102 does not disable the CD source that is integrated with the audio device 101. However, the integrated CD source can be disabled upon connection of the external device 102 if desired.

The modified function of the audio device 101 can include bypass operation. For example, upon connection of the external device 102, the function of the audio device 101 can be modified to simply pass a control signal from the control switch to the external device 102. In this embodiment, the control signal from the control switch controls a function of the external device 102 directly.

In one embodiment, assuming the external device 102 is a CD changer, the control switch (labeled “CD”) can select various CDs in the external device 102. The user can scroll through the available compact disks (including a compact disk that might be loaded in the audio device 101) by repeatedly selecting the control switch (labeled “CD”) on the control panel 114. Thus, the function of the control switch changes depending on the mode of operation (e.g., connection of an external device) of the audio system 100.

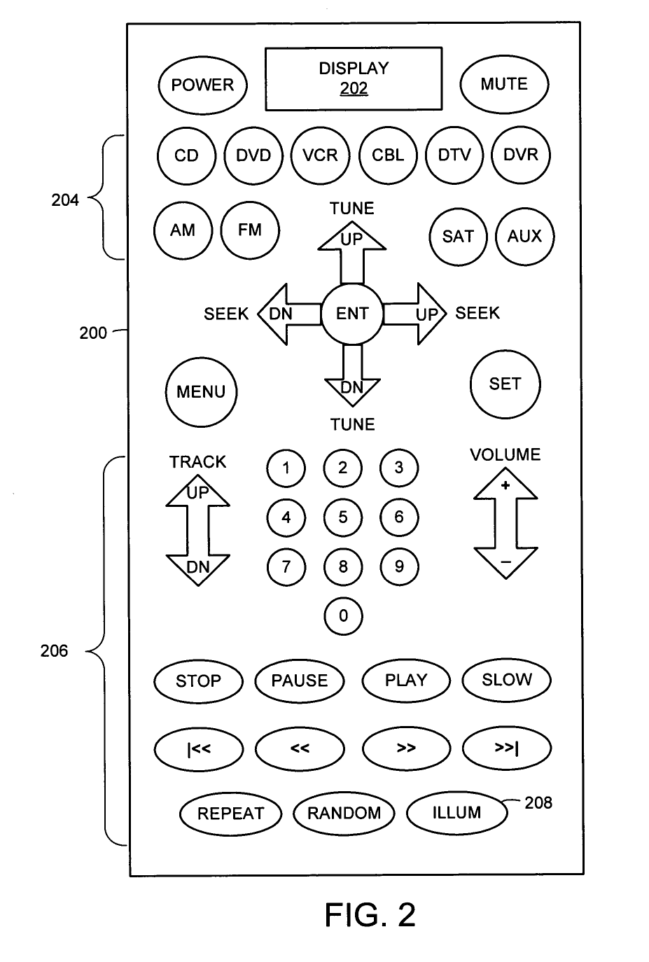

A remote controller 116 can also be used to control the audio device 101. The remote controller 116 can be an infrared (IR) remote controller or a radio frequency (RF) remote controller. The remote controller 116 can embody a programmable touch screen remote controller or can embody a membrane-type remote control having tactile feedback switches, for example. The remote controller 116 can include the same functionality as the control panel 114 and can also include a display screen for displaying system information. An embodiment of a remote controller 116 is described in detail with reference to FIG. 2.

The audio device 101 can include one or more input ports for accepting one or more auxiliary input devices 118. The input port can include an RCA jack, a mini-jack, a RS232 port, a parallel port, a universal serial bus (USB) port, fiber optic port, or any other suitable port. The auxiliary input device 118 is generally controllable through an integrated control panel or a proprietary or universal remote control. For example, the auxiliary input device 118 can include a DVD player/recorder, a VCR, a digital video recorder (DVR), computer, MP3™ player/recorder, mini-disk player, portable music device and/or any other device that is capable of connecting to the audio device 101. Additionally, the auxiliary input device 118 can also include a PDA, a memory stick, a cellular telephone, and/or other portable devices.

The audio device 101 can also include ports for connecting one or more loudspeakers 120, headphones 122 and/or a microphone 124. The loudspeakers 120 can include satellite, surround sound, subwoofer, and/or center channel loudspeakers.

In operation, the audio device 101 is initially connected to the power source 108. The audio device 101 is then activated either through a control switch on the control panel 114 or a control switch on the remote controller 116. The user can then select an audio source in the audio device 101 such as an FM radio station or a compact disk (CD) that is loaded in an integrated compact disk player in the audio device 101. For example, the user can select a control switch on the control panel 114 or on the remote control 116 corresponding to a CD selection function to select the integrated CD source. The audio device 101 receives the command from the control switch and selects the integrated CD player as the audio source. In a first mode of operation, the CD selection function on the control switch selects the integrated CD player regardless of the number of times the control switch is selected.

In a second mode of operation, the external device 102 is connected to the audio device 101. Software that is internal to the audio device 101 detects the connection of the external device 102 and configures software functionality that is required to operate external device 102. In one example, the external device 102 embodies a CD changer that is capable of accommodating multiple compact disks. The user can select the control switch on the control panel 114 or on the remote control 116 corresponding to a CD selection function to select either the CD source that is integrated with the audio device 101 or one of the multiple compact disks in the external device 102. In this second mode of operation, the CD selection function on the control switch selects the integrated CD player in the audio device 101 the first time the user activates the control switch and selects each one of the multiple compact disks in the external device 102 after each subsequent selection of the control switch.

In one embodiment, the software residing in the audio device 101 senses a modified hardware configuration when the external device 102 is connected to the audio device 101. One or more functions that are performed by the audio device 101 prior to the connection of the external device 102 are changed in response to the connection of the external device 102.

The user can control various functions of the audio system 100 including volume, equalization levels, stereo balance, skip track, fast forward, rewind, etc., through various control switches on the control panel 114 and/or on the remote controller 116.

In another illustrative example, a control switch on the controller that corresponds to the skip track function of the audio device 101 can select the next track of a compact disk located inside the audio device 101 in a first mode of operation before the external device 102 is connected to the audio device 101. In a second mode of operation, upon connection of the external device 102 to the audio device 101, the control switch corresponding to the skip track function can control a function of the external device 102. For example, if the external device 102 is a MP3 player, the control switch corresponding to the skip track function can select the next track in the play-list of the MP3 player.

FIG. 2 illustrates a remote controller 200 for controlling the audio system 100 of FIG. 1. The remote controller 200 can embody an IR remote controller or a RF remote controller. In addition, the remote controller 200 can encompass a bi-directional controller that transmits signals to the audio device 101 and receives signals from the audio device 101. For example, the remote controller 200 can include a display 202 that displays information received from the audio device 101 such as system status, artist/track information, station information, and/or any other desired information.

The remote controller 200 includes various control switches 204 that control source selection. The remote controller 200 can be programmable and is designed to function with a variety of components that can connect to the audio device 101. Some of these components contain communication protocols that are native to the audio device 101 and some of these components contain non-native protocols.

The remote controller 200 also includes various control switches 206 for controlling the selected audio track or video track. For example, the control switches can control various functions such as track select, skip forward, skip backward, fast forward, rewind, slow play, pause, play, stop, repeat, random, etc. In one embodiment, one or more of the control switches on the remote controller 200 can be illuminated by selecting an illumination switch 208.

In one embodiment, the remote controller 200 can receive voice commands. The voice commands can be programmed to operate various functions of the remote controller 200. For example, a voice command can be used to operate a control switch on the remote controller 200. The control switch is operated in a virtual sense in the internal circuitry of the remote controller 200.

The remote controller 200 is shown for illustrative purposes only. Various functions can be added to or removed from the remote controller 200 without departing from the invention. Additionally, the control panel 114 of FIG. 1 can include some or all of the functions illustrated by the remote controller 200.

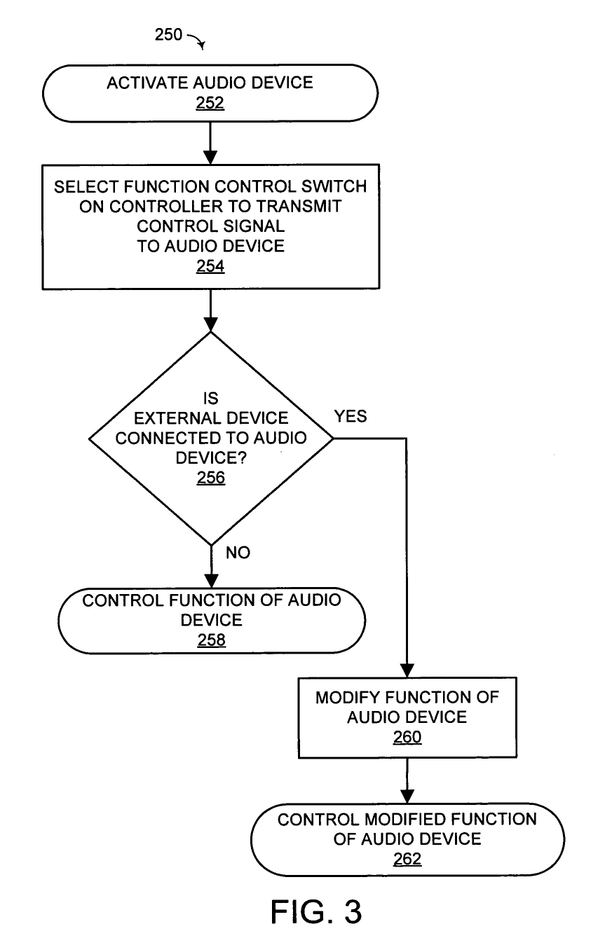

FIG. 3 is a flow chart of a method 250 of controlling the audio system 100 of FIG. 1. In a first step 252, the audio device 101 is activated by selecting a control switch (e.g., power) on the control panel 114 or on the remote controller 116. In a second step 254, a control switch is selected to control a function of the audio device 101. The control switch transmits a control signal to the audio device 101.

In a third step 256, software within the audio device 101 determines whether or not an external device is connected to the audio device 101 before the command received from the control switch is executed. In a fourth step 258, if the software determines that an external device is not connected, the command from the control switch is executed thereby controlling the function of the audio device 101.

In a fifth step 260, if the software within the audio device 101 senses the presence of an external device connected to the audio device 101, the function of the audio device 101 can be modified depending on the transmitted command. In a sixth step 262, if the software modifies the function corresponding to the command, the command from the control switch is executed thereby controlling the modified function of the audio device 101.

In one embodiment, the control switch transmits a control signal to the audio device 101. The control signal controls a function of the audio device 101 before an external device is connected. Once the external device is connected, the control switch then controls a function of the external device. In this embodiment, the function of the audio device 101 is modified to pass the control signal from the control switch to the external device.

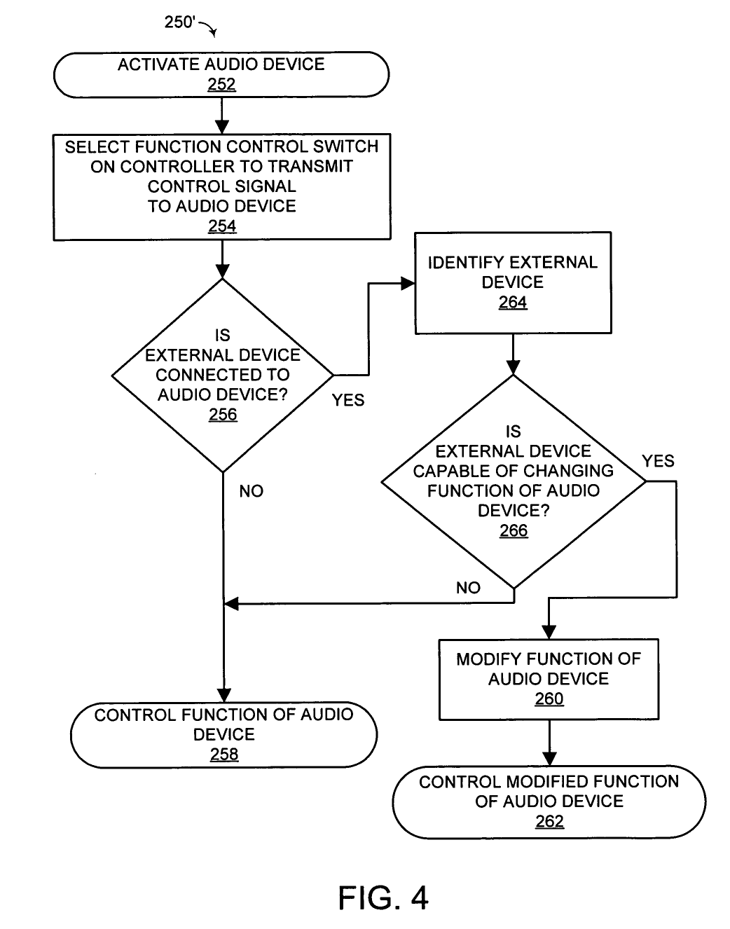

FIG. 4 is a flow chart of another method 250′ of controlling the audio system 100 of FIG. 1. The method 250′ of FIG. 4 is similar to the method 250 of FIG. 3 with the addition of two steps 264, 266. After the software determines that the external device 102 is connected to the audio device 101 (third step 256), the software then optionally identifies the external device 102 (step 264). The software can also determine if multiple external devices 102 are connected to the audio device 101 and the identity of each of the connected devices. The software then determines whether or not the external device 102 is capable of changing the function of the audio device 101 (step 266). For example, if the function being controlled by the control switch is related to controlling the volume level of the audio device 101 and the external device 102 does not include a volume level control function, the volume level of the audio device 101 is controlled regardless of the connection of the external device 102.

If the external device 102 is capable of changing the function of the audio device 101, the function of the audio device 101 is modified (step 260). The modified function is then controlled by the control switch (step 262). For example, if the function being controlled by the control switch is related to selecting a track on a compact disk and the currently active compact disk is within the external device 102, the track selection function of the audio device 101 is modified. Instead of selecting a track of a compact disk that is located within the compact disk player integrated within the audio device 101, the function corresponding to the control switch is modified and a track of the active compact disk that is located within the external device 102 is selected. Other functions of the audio device 101 can be similarly modified upon the connection of the external device 102 to the audio device 101.

The methods 250 and 250′ of FIG. 3 and FIG. 4, respectively, are illustrative methods of controlling the audio system 100 of FIG. 1. Various steps can be added or removed without departing from the invention.

It is evident that those skilled in the art may now make numerous uses and modifications of the specific apparatus and techniques disclosed herein without departing from the inventive concepts. Consequently, the invention is to be construed as embracing each and every novel feature and novel combination of features present in or possessed by the apparatus and techniques herein disclosed and limited only by the spirit and scope of the appended claims.

What is claimed is:

1. An audio system comprising:
an audio device for processing an audio signal;
a controller having a control switch, constructed and arranged to control a function of the audio device; and
an external device coupled to the audio device through a coupling constructed and arranged to modify the function of the audio device such that the control switch controls a modified function of the audio device when the external device is coupled to the audio device.

2. The audio system of claim 1 wherein the control switch is constructed and arranged to control a function of the external device when the external device is coupled to the audio device.

3. The audio system of claim 1 wherein the external device is chosen from the group comprising a MP3 player, a cellular telephone, a satellite telephone, a DVD player, a CD player, a PDA, a digital camera, a multiple-compact disk changer, a portable music device, a radio receiver, a satellite receiver, and another audio device.

4. The audio system of claim 1 wherein the audio device is chosen from the group comprising a multimedia entertainment system, a stereo system, and a computer.

5. The audio system of claim 1 wherein the audio device is chosen from the group comprising an amplifier, a tuner, a CD player, a MP3 player, a DVD player, a cellular telephone, and a storage device.

6. The audio system of claim 1 further comprising an interface element that is coupled between the audio device and the external device.

7. The audio system of claim 6 wherein the interface element is constructed and arranged to translate a communication protocol that is native to the external device to a communication protocol that is native to the audio device.

8. The audio system of claim 6 wherein the interface element is constructed and arranged to translate a communication protocol that is native to the audio device to a communication protocol that is native to the external device.

9. The audio system of claim 1 wherein the controller comprises a remote controller.

10. The audio system of claim 9 wherein the remote controller is constructed and arranged to respond to voice commands.

11. The audio system of claim 1 wherein the controller comprises a control panel that is integrated with the audio device.

12. The audio device of claim 1 wherein the control switch is chosen from the group comprising CD select switch, source select switch, track select switch, skip forward switch, skip backward switch, fast forward switch, rewind switch, pause switch, play switch, slow play switch, stop switch, station select switch, and AM/FM band switch.

13. The audio device of claim 1 wherein the external device is wirelessly coupled to the audio device.

14. The audio device of claim 1 wherein the external device is coupled to the audio device with a cable.

15. The audio device of claim 1 further comprising a docking cradle that is coupled to the audio device and constructed and arranged to receive the external device and couple the external device to the audio device.

16. The audio system of claim 15 wherein the docking cradle further comprises an interface element constructed and arranged to translate a communication protocol that is normative to the audio device to a communication protocol that is native to the audio device.

17. The audio system of claim 15 wherein the docking cradle further comprises an interface element constructed and arranged to translate a communication protocol that is normative to the external device to a communication protocol that is native to the external device.

18. The audio device of claim 1 wherein the external device is constructed and arranged to receive power from the audio device.

19. The audio device of claim 1 wherein the audio device is constructed and arranged to receive power from the external device.

20. A method for controlling an audio system having an audio device with a controller having a control switch comprising:
operating said control switch to transmit a signal to said audio device to control a function of the audio device; and
coupling an external device to the audio device to modify the function of the audio device such that the signal controls a modified function of the audio device when the external device is coupled to the audio device.

21. The method of claim 20 further comprising controlling a function of the external device when the external device is coupled to the audio device.

22. The method of claim 20 further comprising translating a communication protocol that is normative to the audio device to a communication protocol that is native to the audio device.

23. The method of claim 20 further comprising translating a communication protocol that is normative to the external device to a communication protocol that is native to the external device.

24. The method of claim 20 wherein the function of the audio device is chosen from the group comprising CD select function, source select function, track select function, skip forward function, skip backward function, fast forward function, rewind function, pause function, play function, slow play function, stop function, station select function, and AM/FM band function.

25. The method of claim 20 wherein the coupling the external device to the audio device comprises coupling the external device to the audio device with a cable.

26. The method of claim 20 wherein the coupling the external device to the audio device comprises coupling the external device to the audio device wirelessly.

27. The method of claim 20 wherein the coupling the external device to the audio device comprises coupling a docking cradle constructed and arranged to receive the external device to the audio device.

28. The method of claim 20 further comprising powering the external device with the audio device.

29. The method of claim 20 further comprising powering the audio device with the external device.

30. An audio system comprising:
an audio device for processing an audio signal;
a controller having a control switch constructed and arranged to control a function of the audio device;
an interface element that is coupled to the audio device and having a communication protocol that is native to the audio device; and
an external device that is coupled to the interface element constructed and arranged to modify the function of the audio device such that the control switch controls a modified function of the audio device when the external device is coupled to the audio device.

31. The audio system of claim 30 wherein the control switch controls a function of the external device when the external device is coupled to the audio device.

32. The audio system of claim 30 wherein the external device is chosen from the group comprising a MP3 player, a cellular telephone, a satellite telephone, a DVD player, a CD player, a multiple-compact disk changer, a portable music device, a radio receiver, a satellite receiver, and another audio device.

33. The audio system of claim 30 wherein the audio device is chosen from the group comprising a multimedia entertainment system, a stereo system, and a computer.

34. The audio system of claim 30 wherein the audio device is chosen from the group comprising an amplifier, a tuner, a CD player, a MP3 player, a DVD player, a cellular telephone, and a storage device.

35. The audio system of claim 30 wherein the controller comprises a remote controller.

36. The audio system of claim 30 wherein the interface element is constructed and arranged to translate a communication protocol that is native to the external device to a communication protocol that is native to the audio device.

37. The audio system of claim 30 wherein the interface element is constructed and arranged to translate a communication protocol that is native to the audio device to a communication protocol that is native to the external device.

38. The audio device of claim 30 wherein the interface element comprises a docking cradle that is coupled to the audio device and constructed and arranged to receive the external device.
